(19) United States
(12) Patent Application Publication
(10) Pub. No.: US 2014/0039806 A1
(43) Pub. Date: Feb. 6, 2014

(54) ESTIMATING REMAINING USEFUL LIFE FROM PROGNOSTIC FEATURES DISCOVERED USING GENETIC PROGRAMMING

(71) Applicants: Linxia Liao, Plainsboro, NJ (US); Zachery Edmondson, Plainsboro, NJ (US)

(72) Inventors: Linxia Liao, Plainsboro, NJ (US); Zachery Edmondson, Plainsboro, NJ (US)

(73) Assignee: SIEMENS CORPORATION, Iselin, NJ (US)

(21) Appl. No.: 13/950,372

(22) Filed: Jul. 25, 2013

Related U.S. Application Data
(60) Provisional application No. 61/678,742, filed on Aug. 2, 2012.

(51) Int. Cl. G01M 99/00

(52) U.S. Cl. CPC G01M 99/00
USPC 702/34

(57) ABSTRACT

A method for estimating a remaining useful life of a system includes monitoring sensor data from sensors deployed within a system. A plurality of features are extracted from the sensor data. Tree graphs are generated including mathematical operators and features as nodes and a advanced feature is produced from each of the tree graphs by transforming the tree graphs into equations. A recursive operation including analyzing a fitness of each of the advanced features, performing crossover/mutation on the tree graphs, producing advanced features from the altered tree graphs, and analyzing the fitness of the altered tree graphs to produce at least one final advanced feature is performed. A remaining useful life of the system is calculated based on the final advanced feature.

### CROSS-REFERENCE TO RELATED APPLICATION

The present application is based on provisional application Ser. No. 61/678,742, filed Aug. 2, 2012, the entire contents of which are herein incorporated by reference.

### TECHNICAL FIELD

The present disclosure relates to estimating remaining useful life (RUL), and, more specifically, to estimating RUL from prognostic features discovered using generic programming.

### DISCUSSION OF THE RELATED ART

Components of electromechanical machinery often require maintenance or replacement from time to time. Maintenance and replacement that is performed too frequently may result in increased maintenance costs and avoidable service interruptions while preforming maintenance and replacement too late may result in failures that can have potentially catastrophic consequences. It is therefore important to estimate when maintenance/replacement should be performed with a high degree of accuracy.

In determining when a component should be serviced, remaining useful life (RUL) is often estimated. RUL is a measure of how much more use a component can endure before it is required to be serviced. RUL is generally estimated by monitoring the operation of the various components and calculating various features from the data collected during monitoring. For example, temperature sensors and vibration sensors may be installed at various locations within components and these sensors may provide a steady stream of data. This data may then be processed to calculate features such as change in temperature or pattern of vibration. These features may then be monitored to determine when they exceed a predetermined failure threshold. Thereafter, service may be performed on the affected components.

Sensory measurements to be monitored, features to be calculated, and failure thresholds are generally determined manually by an expert based on engineering judgment. In some cases, it may be plainly apparent to an expert which features to rely upon in estimating RUL. However, often, it is particularly difficult to determine which features are well suited for estimating RUL. Features that have the ability to show evidence of future failure may be referred to herein as “prognostic features.” However, even once identified, it may be very difficult to accurately gauge when a failure is imminent from these prognostic features right up until the moment of failure. Thus, accurately estimating RUL throughout the entire useful life of the components may be difficult where feature selection is performed predominantly based on engineering judgment.

### SUMMARY

A method for estimating a remaining useful life of a system includes monitoring sensor data from a plurality of sensors deployed within a system. A plurality of simple features are extracted from the monitored sensor data. Each simple feature represents a function calculated from the sensor data. A population including a plurality of individual tree graphs is generated. Each tree graph includes mathematical operators as non-terminal nodes and at least two of the plurality of simple features as terminal nodes. A advanced feature from each of the individual tree graphs of the population is produced by transforming the tree graphs into equations in which the mathematical operators are operators in the equation and the at least two simple features are operands. A recursive operation including analyzing a fitness of each of the advanced features to act as a prognostic feature for assessing the system, altering the tree graphs by performing crossover or mutation, producing advanced features from the altered tree graphs, and analyzing the fitness of the altered tree graphs to produce at least one final advanced feature is performed. A remaining useful life of the system is calculated based on the at least one final advanced feature.

The method may be performed after it is discovered that none of the plurality of simple features is sufficiently fit to calculating the remaining useful life of the system.

The system may be an electromechanical system or an industrial facility.

The sensor data may include a temperature sensor or a vibrational sensor.

The plurality of simple features may include a root mean squared feature.

Each of the individual tree graphs may be of a fixed depth.

Each of the individual tree graphs may have a fixed initial depth and the depth of each tree graph may increase during subsequent recursion.

The mathematical operators may include addition, subtraction, multiplication, division, and/or square root.

In transforming the tree graphs into equations, the hierarchy of the tree graph may determine the order in which each of the equations is arranged.

Monotonicity may be calculated in analyzing a fitness of each of the advanced features to act as a prognostic feature for assessing the system.

A structure of each of the individual tree graphs may be generated at random.

In generating the population of individual tree graphs, the mathematical operators and the at least two of the plurality of simple features may be selected at random.

A determination as to whether and how to perform crossover or mutation on each of the tree graphs may be made at random with respect to each tree graph.

Alterations that reduce analyzed fitness may be undone and alterations that increase analyzed fitness may be preserved.

Recursion may be continued until a maximum number of iterations have been performed.

Recursion may be continued until fitness of at least one of the advanced features is maximized.

A computer system includes a processor and a non-transitory, tangible, program storage medium, readable by the computer system, embodying a program of instructions executable by the processor to perform method steps for estimating a remaining useful life of a system. The method includes monitoring sensor data from a plurality of sensors deployed within a system. A plurality of simple features is extracted from the monitored sensor data. Each simple feature represents a function calculated from the sensor data. Genetic programming is utilized to produce at least one advanced feature from the plurality of simple features. A remaining useful life of the system is calculated based on the at least one advanced feature.

Utilizing genetic programming to produce at least one advanced feature from the plurality of simple features may include generating a population including a plurality of individual tree graphs, each tree graph including mathematical operators as non-terminal nodes and at least two of the plurality of simple features as terminal nodes, producing a advanced feature candidate from each of the individual tree graphs of the population by transforming the tree graphs into equations in which the mathematical operators are operators in the equation and the at least two simple features are operands, and recursively analyzing a fitness of each of the advanced feature candidates to act as a prognostic feature for assessing the system, altering the tree graphs by performing crossover or mutation, producing advanced features candidates from the altered tree graphs, and analyzing the fitness of the altered tree graphs to produce the at least one advanced feature.

A method for estimating a remaining useful life of a system includes monitoring sensor data from a plurality of sensors deployed within a system. Each of a set of simple features is used to attempt to predict a remaining useful life of a system. Each simple feature represents a function calculated from the sensor data. When it is determined that none of the simple features is sufficiently fit to predict the remaining useful life of the system, genetic programming is utilized to produce at least one advanced feature from the plurality of simple features. A remaining useful life of the system is calculated based on the at least one advanced feature.

Utilizing genetic programming to produce at least one advanced feature from the plurality of simple features may include generating a population including a plurality of individual tree graphs, each tree graph including mathematical operators as non-terminal nodes and at least two of the plurality of simple features as terminal nodes. A advanced feature candidate may be produced from each of the individual tree graphs of the population by transforming the tree graphs into equations in which the mathematical operators are operators in the equation and the at least two simple features are operands. The following steps may be recursively performed: analyzing the fitness of each of the advanced feature candidates to act as a prognostic feature for assessing the system, altering the tree graphs by performing crossover or mutation, producing advanced features candidates from the altered tree graphs, and analyzing the fitness of the altered tree graphs to produce the at least one advanced feature.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a system for estimating RUL from prognostic features discovered using generic programming in accordance with exemplary embodiments of the present invention;

FIG. 2 is a flow chart illustrating an approach for estimating RUL from prognostic features discovered using generic programming in accordance with exemplary embodiments of the present invention;

FIG. 3 is an exemplary tree graph illustrating genetic programming applied to the automatic discover new prognostic features in accordance with exemplary embodiments of the present invention; and

FIG. 4 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to automatically perform selection of prognostic features that may be used to accurately estimate remaining useful life (RUL) throughout the entire useful life of components of electromechanical machinery. This selection may be based on principals of genetic programming, whereby various prognostic feature candidates may be tried, their fitness may be measured, and the feature candidates recursively modified as measured fitness is optimized. However, where none of the feature candidates meet a predetermined fitness threshold, even after a significant number of recursive modifications, exemplary embodiments of the present invention may then provide an approach for selecting a new set of feature candidates from measurements made and/or previously considered feature candidates.

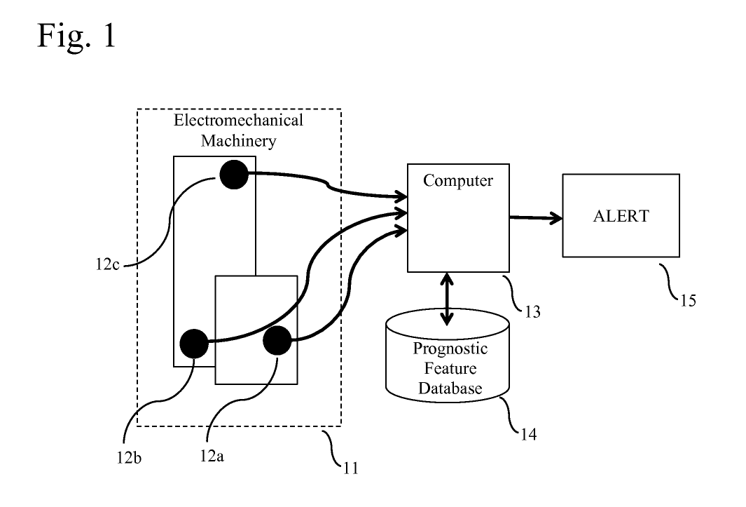

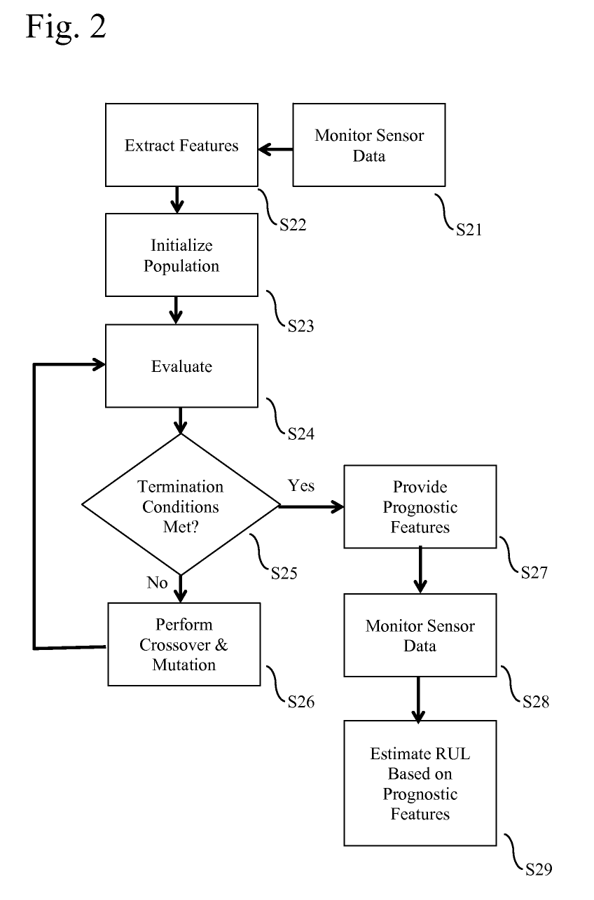

FIG. 1 is a schematic diagram illustrating a system for estimating RUL from prognostic features discovered using generic programming in accordance with exemplary embodiments of the present invention. FIG. 2 is a flow chart illustrating an approach for estimating RUL from prognostic features discovered using generic programming in accordance with exemplary embodiments of the present invention.

The system under test may include electromechanical machinery 11, although exemplary embodiments of the present invention may be used to predict RUL on other forms of systems as well and may also be used to monitor chemical processes and to predict the termination of such processes. However, for the purposes of providing a simplified explanation, exemplary embodiments may be described herein in terms of electromechanical machinery.

The electromechanical machinery 11 may include one or more systems that may include electronic and/or mechanical parts. The phrase electromechanical machinery is used broadly here and may include anything from a single machine to a complex industrial facility. The electromechanical machinery 11 may also include purely electronic components and need not necessarily include moving parts.

One or more sensors 12 may be installed throughout the electromechanical machinery 11. Sensors may include temperature sensors, vibration sensors, light sensors, pressure sensors, humidity sensors, and various other condition sensors. However, the sensors may also include logical sensors that may monitor the performance of digital electronics such as CPU utilization sensors, free memory sensors, etc. It is to be understood that logical sensors may be instantiated as routines executing within a computer system that monitor and report on conditions of the computer system.

In FIG. 1, three sensors 12a, 12b, and 12c are shown. However, there may be any number of sensors installed within the electromechanical machinery 11. The output from the sensors 12 may be sent to a computer system 13 for analysis. Logical sensor data may be communicated from one computer to another or may be sent from one program to another within a single computer. The computer system 13 may be responsible for calculating features from the sensor data and for performing prognostic feature discovery as discussed in detail herein. Discovered prognostic features may be stored in a database 14 for later use.

Use of the prognostic features may also include receiving sensor data from the sensors 12a, 12b, and 12c installed within the electromechanical machinery 11 and calculating the prognostic features within the computer system 13 or another computer system, based on the prognostic features discovered and stored in the database 14. RUL may be calculated based on the prognostic features and the RUL value may be displayed on a display device 15, for example, as an alert providing an indication of when maintenance should be scheduled.

As may be seen from FIG. 2, the process may begin by monitoring sensor data from the one or more sensors 12a, 12b, and 12c (Step S21). The sensor data monitored for the purposes of discovering the prognostic features may be acquired from the same electromechanical machinery 11 that is the subject of the monitoring for estimating RUL. Thus, the prognostic features may be discovered for the very equipment under test. However, exemplary embodiments of the present invention may alternatively discover prognostic features on similar but not identical electromechanical machinery 11.

The monitoring of the sensor data (Step S21) may be continuous and thus the sensor data may be a stream of data. As the sensor data is being monitored, features may be extracted from the sensor data stream (Step S22). Alternatively, sensor data may be acquired for a predetermined length of time and features may be extracted from this sensor data (Step S22).

Feature extraction (Step S22) entails performing calculations on data output from one or more sensors in order to produce a value that may be indicative of a state of the system being evaluated. Thus data from multiple sensors may be used in calculating a single feature or portions of data from a single sensor may be used to calculate multiple features. A good prognostic feature is one that displays a steady progression and obvious trend through out the entire life cycle of the machinery being evaluated. In this way, not only can an imminent failure be predicted, but an accurate RUL may be predicted throughout the entire life cycle.

In extracting features, any mathematical and/or statistical functions may be performed on the sensor data from one or more sensors. For example, calculating the root mean square (RMS) of a vibration sensor may yield a feature. Temperature may be a feature, even as it may also be sensor data. However, perhaps more commonly, current through a thermocouple may be considered sensor data and a temperature calculated therefrom may be considered a feature.

Generally, most features are simple features, understood herein as the result achieved by performing a function on output data of one or more sensors. For example, vibration RMS is a simple feature, as is performing a Fourier Transform on vibration data to isolate and quantify vibration of a particular frequency or to analyze a change in frequency distribution of vibration over time. Band-pass filters and wavelet filters may also be used to produce simple features. Simple features are generally known and understood and have some logical underpinnings and thus may be based on technical understanding. Simple features are generally designed by humans and are based on scientific and/or engineering knowledge and/or experience.

Although simple features may be prognostic, often times they provide no prognostic value until, for example, right at the moment of failure. Thus exemplary embodiments of the present invention seek to find advanced features of prognostic value when simple features are insufficient to provide an estimate for RUL. An advanced feature, as understood herein, may be a mathematical combination of a group of features, or may otherwise be a mathematical computation that is involved and thus it may be difficult to appreciate the prognostic value of the feature simply by examining the mathematical computation. Unlike simple features, which have technical underpinnings, advanced features are generally unknown, automatically created incorporating random elements, and are not designed based on scientific and/or engineering knowledge.

Feature extraction (Step S22), in accordance with exemplary embodiments of the present invention, may decompose the multiple sensor data into a feature space which is relevant to the equipment health status using various signal processing algorithms. For example, special techniques used to analyze waveform data may be used, such as, time domain analysis, RMS, mean average value, Kurtosis, Crest factor, and skewness from vibration signals. Various equations may be used to extract these features from the sensor data. For example, fast Fourier Transform (FFT) may be used to decompose a waveform signal from sensor data into a spectrum of component frequencies and their amplitudes. The energies (for example, defined as a sum of the square of amplitudes) over the various frequency bands centered on specific frequencies (for example, rotating frequency and its harmonics and/or bearing passing frequency at outer race) may be calculated as features. For example, if the rotating frequency of a component is 50 Hz and the frequency band width is selected at 5 Hz, the sum of the squares of the amplitudes over a frequency range of 50+/−5 Hz in the FFT spectrum may be calculated as energy features. Additional signal processing methods, for example, wavelet analytics, etc., may be employed to extract features in this step. In fact, many other common feature extraction techniques may be used at this step.

Exemplary embodiments of the present invention may be used after no known feature extraction techniques result in a feature with sufficient prognostic value. Thus exemplary embodiments of the present invention may go on to discover new prognostic features using genetic programming.

Genetic programming involves defining a function set, which is a set of simple mathematical functions that can be applied to numbers (e.g., plus, minus, divided by, multiplied by, square root, etc.), and defining a terminal set, which is a set of mathematical operands and then randomly establishing a tree graph in which every node is a mathematical function and every terminal node is an operand. The tree then represents a new randomly created mathematical function.

Genetic programming may be applied to automatically discover new prognostic features by randomly generating a new feature from existing features and then evaluating its prognostic value as the new feature is recursively modified. In applying genetic programming to automatic discovery of new prognostic features, the operands of the terminal nodes may be features, for example, Fᵢ (for i=1, 2, 3, . . . ), that were extracted in Step S22. These features may be features understood within the art to have prognostic value with respect to certain systems but are unfortunately not particularly valuable for assessing RUL for the present system under analysis.

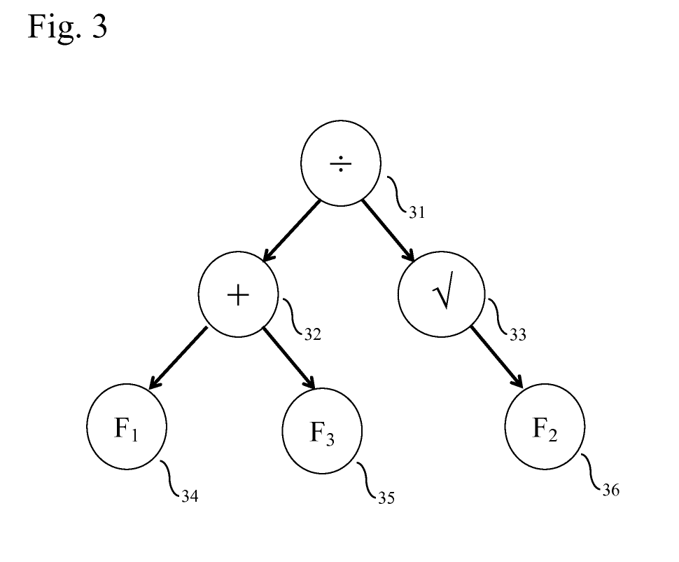

FIG. 3 is an exemplary tree graph illustrating genetic programming applied to the automatic discover new prognostic features in accordance with exemplary embodiments of the present invention. In the example shown, division is assigned to a first node 31, addition is assigned to a second node 32, square root to a third node 33, and to terminal nodes 34, 35, and 36 are assigned three features F₁, F₃, and F₂, respectively. The resulting tree graph may be read as the following equation:

$$F = \frac{{F}_{1} + {F}_{3}}{\sqrt{{F}_{2}}} \qquad ( 1 )$$

As discussed above, the features Fᵢ (for i=1, 2, 3, . . . ) may be the features extracted in Step S22 pursuant to known feature extraction techniques.

Multiple initial tree graphs may be created. Each graph may be considered an individual and the group of tree graphs may be considered a population. This construction of the population of individual initial tree graphs may be considered population initialization (Step S23). Here, the initial tree graphs may be established from the function set and the terminal set, as well as a desired level of depth, which here is shown to be set as three for the purposes of providing a simple explanation, although any number of levels may be used. The depth of the tree structure need not be fixed and may grow during successive iterations of the genetic programming.

Thus in initializing the population, advanced features F (one for each individual tree graph) are randomly defined from the set of simple features F₁, F₂, and F₃.

Then, the advanced features are evaluated (Step S24). Evaluation of the advanced features may include calculating a fitness function to determine a fitness score representing an ability of the advanced feature to estimate RUL for each individual. As the purpose of finding a prognostic feature is to estimate RUL, an optimal feature may be able to demonstrate a continuous and predictable progression as a fault develops during degradation of the system under analysis. Monotonicity, which is a mathematical criterion, may be used as a measure of this trend, which may represent the fitness of the feature. Monotonicity may be defined herein according to the equation:

$$Monotonicity ( F ) = \vert \frac{\# of \frac{d}{d F} > 0}{n - 1} - \frac{\# of \frac{d}{d F} < 0}{n - 1} \vert \qquad ( 2 )$$

Here n is the number of observations in a period of time. F represents the feature being tested and d/dF is its derivative. The function is given an absolute sign so that the maximum value of Monotonicity is equal to 1 only if the feature is monotonically increasing or decreasing.

Monotonicity, as established herein, may always be low when the feature contains noise. Thus there is a preference for smooth, higher-order polynomial functions that may avoid noise and better represent a trend of the feature.

After the created feature is evaluated in terms of monotonicity (Step S24), it may be determined whether termination conditions have been satisfied (Step S25). Termination conditions may be both a predefined number of iterations and when a maximum fitness value is reached by at least one individual in the population, which ever may come first.

If the termination conditions are not satisfied (No, Step S25), then the individual tree graphs may be modified by performing crossover/mutation (Step S26). Crossover is the switching of one node with another node from another individual within the same population. The nodes that branch off of the node that is being switched may also be switched. Thus, whole branches of the graph may be switched. Which branches are switched may be determined randomly.

Mutation is the changing of a node or a branch of nodes for other values that could have been selected initially. Mutation involves only one individual from a population. Thus a non-terminal node may be replaced for another operator while a terminal node may be replaced for another simple feature. This replacement may also be performed randomly. In fact, whether to perform crossover or mutation may be determined randomly.

After each iteration of crossover/mutation (Step S26), evaluation may be repeated for each individual in the population (Step S4). Those individuals that demonstrate an improved fitness may be kept as they are while those individuals that show a reduced fitness may be reverted to the prior version. The terminating conditions may be checked for again and the process may repeat until termination conditions are satisfied (Yes, Step S25). When terminating conditions are satisfied (Yes, Step S25), one or more features having the highest fitness may be provided as prognostic features (Step S27). Thereafter, sensor data may be monitored in terms of the prognostic features (Step S28) and RUL may be estimated therefrom (Step S29).

The prediction of the RUL may be performed using the discovered features. Many suitable statistical data driven approaches may be used in this regard. For example, the RUL may be estimated using a continuous Bayesian update assuming the underline distribution of the discovered feature is an exponential distribution. After solving the parameter estimation of the exponential distribution, the parameters may be projected over time and/or use to estimate the future projection of the feature. The time from the starting of the prediction to the time when the predicted performance deviation reaches a predefine failure threshold may be output as an indicator of remaining useful like (RUL). Parameter estimation may be performed using any suitable approach, for example, a particle filter approach may be used.

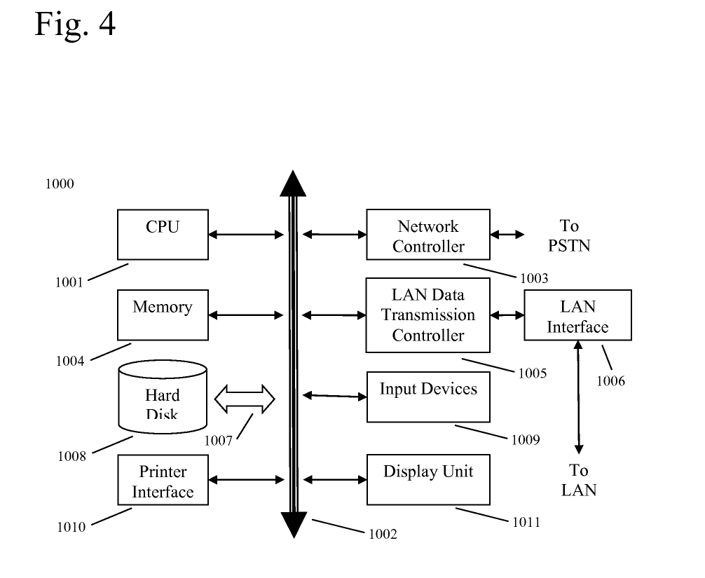

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for estimating a remaining useful life of a system, comprising:
monitoring sensor data from a plurality of sensors deployed within a system;
extracting a plurality of simple features from the monitored sensor data, each simple feature representing a function calculated from the sensor data;
generating a population including a plurality of individual tree graphs, each tree graph including mathematical operators as non-terminal nodes and at least two of the plurality of simple features as terminal nodes;
producing a advanced feature from each of the individual tree graphs of the population by transforming the tree graphs into equations in which the mathematical operators are operators in the equation and the at least two simple features are operands;
recursively analyzing a fitness of each of the advanced features to act as a prognostic feature for assessing the system, altering the tree graphs by performing crossover or mutation, producing advanced features from the altered tree graphs, and analyzing the fitness of the altered tree graphs to produce at least one final advanced feature; and
calculating a remaining useful life of the system based on the at least one final advanced feature.

2. The method of claim 1, wherein the method is performed after it is discovered that none of the plurality of simple features is sufficiently fit to calculating the remaining useful life of the system.

3. The method of claim 1, wherein the system is an electromechanical system or an industrial facility.

4. The method of claim 1, wherein the sensor data includes a temperature sensor or a vibrational sensor.

5. The method of claim 1, wherein the plurality of simple features includes a root mean squared feature.

6. The method of claim 1, wherein each of the individual tree graphs are of a fixed depth.

7. The method of claim 1, wherein each of the individual tree graphs have a fixed initial depth and the depth of each tree graph increases during subsequent recursion.

8. The method of claim 1, wherein the mathematical operators include addition, subtraction, multiplication, division, or square root.

9. The method of claim 1, wherein in transforming the tree graphs into equations, the hierarchy of the tree graph determines the order in which each of the equations is arranged.

10. The method of claim 1, wherein monotonicity is calculated in analyzing a fitness of each of the advanced features to act as a prognostic feature for assessing the system.

11. The method of claim 1, wherein a structure of each of the individual tree graphs is generated at random.

12. The method of claim 1, wherein in generating the population of individual tree graphs, the mathematical operators and the at least two of the plurality of simple features are selected at random.

13. The method of claim 1, wherein a determination as to whether and how to perform crossover or mutation on each of the tree graphs is made at random with respect to each tree graph.

14. The method of claim 1, wherein alterations that reduce analyzed fitness are undone and alterations that increase analyzed fitness are preserved.

15. The method of claim 1, wherein recursion is continued until a maximum number of iterations have been performed.

16. The method of claim 1, wherein recursion is continued until fitness of at least one of the advanced features is maximized.

17. A computer system comprising:
a processor; and
a non-transitory, tangible, program storage medium, readable by the computer system, embodying a program of instructions executable by the processor to perform method steps for estimating a remaining useful life of a system, the method comprising:
monitoring sensor data from a plurality of sensors deployed within a system;
extracting a plurality of simple features from the monitored sensor data, each simple feature representing a function calculated from the sensor data;
utilizing genetic programming to produce at least one advanced feature from the plurality of simple features; and
calculating a remaining useful life of the system based on the at least one advanced feature.

18. The method of claim 17, wherein utilizing genetic programming to produce at least one advanced feature from the plurality of simple features, comprises:
generating a population including a plurality of individual tree graphs, each tree graph including mathematical operators as non-terminal nodes and at least two of the plurality of simple features as terminal nodes;
producing a advanced feature candidate from each of the individual tree graphs of the population by transforming the tree graphs into equations in which the mathematical operators are operators in the equation and the at least two simple features are operands; and
recursively analyzing a fitness of each of the advanced feature candidates to act as a prognostic feature for assessing the system, altering the tree graphs by performing crossover or mutation, producing advanced features candidates from the altered tree graphs, and analyzing the fitness of the altered tree graphs to produce the at least one advanced feature.

19. A method for estimating a remaining useful life of a system, comprising:
monitoring sensor data from a plurality of sensors deployed within a system;
utilizing each of a set of simple features to attempt to predict a remaining useful life of a system, each simple feature representing a function calculated from the sensor data,
wherein when it is determined that none of the simple features is sufficiently fit to predict the remaining useful life of the system:
genetic programming is utilized to produce at least one advanced feature from the plurality of simple features; and
a remaining useful life of the system is calculated based on the at least one advanced feature.

20. The method of claim 19, wherein utilizing genetic programming to produce at least one advanced feature from the plurality of simple features, comprises:
generating a population including a plurality of individual tree graphs, each tree graph including mathematical operators as non-terminal nodes and at least two of the plurality of simple features as terminal nodes;
producing a advanced feature candidate from each of the individual tree graphs of the population by transforming the tree graphs into equations in which the mathematical operators are operators in the equation and the at least two simple features are operands; and
recursively analyzing a fitness of each of the advanced feature candidates to act as a prognostic feature for assessing the system, altering the tree graphs by performing crossover or mutation, producing advanced features candidates from the altered tree graphs, and analyzing the fitness of the altered tree graphs to produce the at least one advanced feature.
